(19) United States
(12) Patent Application Publication
(10) Pub. No.: US 2026/0139658 A1
(43) Pub. Date: May 21, 2026

(54) Distributed Energy Interface Infrastructure Systems for Non-Rotational Environmental Energy Extraction

(71) Applicant: Tysaiah Floyd Franklin, Peculair, MO (US)

(72) Inventor: Tysaiah Floyd Franklin, Peculair, MO (US)

(21) Appl. No.: 19/445,356

(22) Filed: Jan. 9, 2026

(51) Int. Cl. F03D 9/00; F03B 13/18; F03D 5/06

(52) U.S. Cl. CPC F03D 9/008; F03B 13/1845; F03D 5/06; F05B 2220/706

(57) ABSTRACT

An energy infrastructure system is disclosed comprising aerial and aquatic platforms configured for sustained deployment and extraction of usable energy from environmental flows through non-rotational interaction. The platforms may operate independently or cooperatively to extract energy from airflow and water movement and to route extracted energy to external infrastructure, storage systems, or consumption modules. The disclosed system enables distributed, multi-environment energy extraction without reliance on rotational turbine assemblies or fixed-location generation assets.

### CROSS-REFERENCE TO RELATED APPLICATIONS

This application is a continuation-in-part of U.S. patent application Ser. No. 19/347,711, filed on Dec. 29, 2025, the entire contents of which are incorporated herein by reference.

### TECHNICAL FIELD

The present disclosure relates to distributed energy infrastructure systems, and more particularly to aerial and aquatic platforms configured to extract usable energy from environmental flows through non-rotational interaction and to route such energy for infrastructure-level use.

### BACKGROUND

Conventional energy infrastructure relies primarily on fixed location assets and rotational turbine-based generation mechanisms, which introduce mechanical complexity, maintenance overhead, deployment constraints, and limited adaptability to dynamic environmental conditions.

Such systems are poorly suited for distributed deployment across multiple environments, including aerial and aquatic domains, and lack the ability to continuously extract energy from environmental flows without reliance on large-scale mechanical assemblies.

Additionally, conventional systems lack the ability to coordinate energy extraction across vertically separated environments using interoperable platforms operating as infrastructure units.

### SUMMARY

Disclosed are systems and methods for distributed energy infrastructure platforms capable of sustained deployment and interaction with environmental flows across multiple environments, wherein usable energy is extracted through non-rotational interaction and routed for infrastructure level use. In some embodiments, aerial and aquatic platforms operate independently or cooperatively to provide continuous energy services without reliance on fixed location or turbine based generation systems.

In some embodiments, the disclosed system supports energy as a service or infrastructure leasing models through selective routing of extracted energy.

### DETAILED DESCRIPTION

In some embodiments, an energy Extracting system comprises one or more aerial platforms and one or more aquatic platforms configured to operate cooperatively as a distributed energy interface system.

The aerial platform may be configured for sustained operation at altitude and may extract energy from environmental airflow through non-rotational aerodynamic interaction, including pressure differentials, airflow-induced oscillation, structural vibration, or distributed force responses generated by interaction between the platform and surrounding air.

The aquatic platform may be deployed on, partially submerged within, or fully submerged beneath a body of water and may extract energy from water movement, including wave motion, current flow, pressure variation, or fluid-induced vibration, without reliance on rotational turbine assemblies.

In some embodiments, the aerial platform and aquatic platform are communicatively coupled such that operational data, energy availability data, system status, or routing instructions may be exchanged between platforms. Extracted energy from either platform may be routed.
independently or cooperatively to ground-based infrastructure, intermediate relay systems, storage systems, or localized consumption modules.

In certain embodiments, the aerial platform may supply energy, control signals, or operational coordination to the aquatic platform, and the aquatic platform may supply energy, stability data, or environmental data to the aerial platform, forming a vertically distributed energy interface spanning air and water environments.

Energy extraction may occur while the aerial platform is stationary or relocating, and while the aquatic platform is stationary, drifting, anchored, or dynamically positioned. Energy conditioning and routing may be performed to ensure compatibility with downstream infrastructure without requiring permanent integration of storage systems on either platform.

The cooperative operation of aerial and aquatic platforms enables continuous, multi-environment energy extraction using distributed structures that operate as infrastructure units rather than standalone generators.

1. An energy interface system comprising: an aerial platform configured to extract energy from environmental airflow through non-rotational interaction; an aquatic platform configured to extract energy from water movement through non-rotational interaction;
and an energy routing interface configured to route extracted energy to one or more external infrastructure systems, wherein the aerial and aquatic platforms operate independently or cooperatively as a distributed energy infrastructure system.

2. The system of claim 1, wherein the aerial platform extracts energy from airflow-induced pressure differentials.

3. The system of claim 1, wherein the aquatic platform extracts energy from wave motion, current flow, or fluid-induced vibration.

4. The system of claim 1, wherein the aerial and aquatic platforms are communicatively coupled.

5. The system of claim 1, wherein extracted energy is routed to external infrastructure, storage systems, or consumption modules.

6. The system of claim 1, wherein energy extraction occurs while at least one platform is relocating.

7. The system of claim 1, wherein the system operates as distributed infrastructure across multiple environmental domains.

8. The system of claim 1, wherein energy extraction is performed without reliance on rotational turbine assemblies.

9. The system of claim 1, further comprising energy conditioning configured to enable compatibility with downstream grid infrastructure.

10. The system of claim 1, wherein the aquatic platform is deployed on, partially submerged within, or fully submerged beneath a body of water.

11. The system of claim 1, wherein the aerial platform is buoyant or aerodynamically supported.

12. The system of claim 1, wherein extracted energy is selectively routed among multiple external entities.

13. The system of claim 1, wherein the system maintains partial operation when one platform is inactive.

14. The system of claim 1, wherein energy is extracted concurrently from air and water environments.

15. The system of claim 1, wherein the system is configured for sustained operation.

16. The system of claim 1, wherein the system is modular.

17. The system of claim 1, wherein the system interfaces with one or more energy storage systems.

18. The system of claim 1, wherein energy routing is responsive to demand conditions.

19. The system of claim 1, wherein the system forms a vertically distributed energy interface spanning air and water environments.

20. The system of claim 1, wherein the system provides energy as an infrastructure service.

21. The system of claim 1, wherein transfer of extracted energy occurs via controlled routing interfaces including conductive coupling, inductive coupling, mechanical transfer, fluid-mediated transfer, or intermediary storage exchange, without reliance on free-space microwave, radio-frequency beamforming, phased-array targeting, or directed electromagnetic power transmission.

22. The system of claim 1, wherein extracted energy is routed as an infrastructure-level resource to shared storage systems, grid-interface systems, relay platforms, or distributed energy nodes, rather than as targeted transmission to individual end-device batteries.

23. The system of claim 1, wherein extracted energy is selectively redistributed among multiple aerial or aquatic platforms to balance operational load, maintain service continuity, or compensate for localized environmental variability.

24. The system of claim 1, wherein energy routing or transfer operations occur concurrently with ongoing energy extraction and service functions and do not require suspension of primary platform operation or exclusive alignment between transfer participants.
